(19) United States
(12) Patent Application Publication
(10) Pub. No.: US 2024/0336110 A1
(43) Pub. Date: Oct. 10, 2024

(54) HVAC Airflow Throttling Mechanism

(71) Applicant: DENSO International America, Inc., Southfield, MI (US)

(72) Inventors: Kyle STABILE, Livonia, MI (US); Brian BELANGER, Rochester Hills, MI (US)

(73) Assignee: DENSO International America, Inc., Southfield, MI (US)

(21) Appl. No.: 18/614,026

(22) Filed: Mar. 22, 2024

Related U.S. Application Data
(60) Provisional application No. 63/494,328, filed on Apr. 5, 2023.

(51) Int. Cl. B60H 1/00

(52) U.S. Cl. CPC B60H 1/00692; B60H 1/00849; B60H 2001/00721

(57) ABSTRACT

A vehicle HVAC system including a ram air throttling assembly. The ram air throttling assembly includes: a housing defining a ram air inlet, a recirculation air inlet, and an outlet; a first door within the housing, the first door movable to direct airflow from at least one of the ram air inlet and the recirculation air inlet to the outlet; and a second door slidably movable to throttle airflow into the housing through the ram air inlet.

### CROSS-REFERENCE TO RELATED PATENT APPLICATION

This application claims the benefit of U.S. Provisional Patent Application No. 63/494,328 filed on Apr. 5, 2023, the entire disclosure of which is incorporated herein by reference.

### FIELD

The present disclosure relates to a ram air throttling mechanism for a vehicle heating, ventilation, and air conditioning (HVAC) system.

### BACKGROUND

This section provides background information related to the present disclosure, which is not necessarily prior art.

Vehicles often utilize ram air to supply additional air to the HVAC system and/or the engine's intake system. The vehicle's forward motion is used to force ram air into ducts or intakes positioned in areas where air pressure is relatively high, such as at a front of the vehicle. As the vehicle moves forward, the incoming air is rammed into the intakes, which increases the pressure and volume of air available to the HVAC system and/or the engine.

### SUMMARY

This section provides a general summary of the disclosure, and is not a comprehensive disclosure of its full scope or all of its features.

The present disclosure includes a vehicle HVAC system including a ram air throttling assembly. The ram air throttling assembly includes: a housing defining a ram air inlet, a recirculation air inlet, and an outlet; a first door within the housing, the first door movable to direct airflow from at least one of the ram air inlet and the recirculation air inlet to the outlet; and a second door slidably movable to throttle airflow into the housing through the ram air inlet.

In further features, the first door is a barrel door.

In further features, the outlet is in communication with a blower and an HVAC case of the vehicle HVAC system.

In further features, the ram air inlet is opposite to the recirculation air inlet.

In further features, the outlet is between the ram air inlet and the recirculation air inlet.

In further features, the second door is slidably movable into and out of a pocket defined by the housing.

In further features, the second door is slidably movable in a direction perpendicular to airflow through the ram air inlet.

In further features, the second door includes a plate having door teeth meshed with gear teeth of a gear such that rotation of the gear slides the second door between an open position, a closed position, and an intermediate position between the open position and the closed position.

In further features, a motor is configured to rotate the gear.

In further features, the ram air inlet is a first ram air inlet; the housing further defines a second ram air inlet; and the second door is slidably movable to throttle airflow into the housing through both the first ram air inlet and the second ram air inlet.

In further features, the first ram air inlet is vertically aligned with the second ram air inlet.

In further features, the housing includes two of the first doors each adjacent to a different one of the first ram air inlet and the second ram air inlet.

The present disclosure further includes, in various features, a vehicle HVAC system including a ram air throttling assembly including: a housing defining a ram air inlet, a recirculation air inlet, and an outlet; a first door within the housing, the first door movable to direct airflow from at least one of the ram air inlet and the recirculation air inlet to the outlet; and a second door at the ram air inlet, the second door configured as a plate slidably movable into and out of a pocket defined by the housing in a direction perpendicular to airflow through the ram air inlet to throttle airflow into the housing through the ram air inlet.

In further features, the second door includes door teeth meshed with gear teeth of a gear such that rotation of the gear slides the second door between an open position, a closed position, and an intermediate position between the open position and the closed position; and the vehicle HVAC system further includes a motor configured to rotate the gear.

In further features, the ram air inlet is opposite to the recirculation air inlet.

In further features, the ram air inlet is a first ram air inlet; the housing further defines a second ram air inlet vertically aligned with the first ram air inlet; and the second door is slidably movable to throttle airflow into the housing through both the first ram air inlet and the second ram air inlet.

The present disclosure also includes, in various features, a vehicle HVAC system including: an HVAC case including an evaporator and a heater; a blower connected to the HVAC case and configured to blow air through the HVAC case; and a ram air throttling assembly connected to the blower. The ram air throttling assembly includes: a housing defining a ram air inlet, a recirculation air inlet, and an outlet; a first door within the housing, the first door movable to direct airflow from at least one of the ram air inlet and the recirculation air inlet to the outlet; and a second door slidably movable to throttle airflow into the housing through the ram air inlet.

In further features, the second door includes door teeth meshed with gear teeth of a gear such that rotation of the gear slides the second door between an open position, a closed position, and an intermediate position between the open position and the closed position; and the vehicle HVAC system further includes a motor configured to rotate the gear.

In further features, the ram air inlet is opposite to the recirculation air inlet.

In further features, the ram air inlet is a first ram air inlet; the housing further defines a second ram air inlet vertically aligned with the first ram air inlet; and the second door is slidably movable to throttle airflow into the housing through both the first ram air inlet and the second ram air inlet.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a cross-sectional view of a portion of a vehicle including an exemplary HVAC system with a ram air throttling assembly in accordance with the present disclosure;

FIG. 2A illustrates the ram air throttling assembly in a recirculation mode with a mode door positioned to direct recirculated cabin air to an HVAC case and block ram air from entering the HVAC case, and a ram air throttling door in an open position;

FIG. 2B illustrates the ram air throttling assembly of FIG. 2A in a fresh air mode with the mode door positioned to direct fresh ram air to the HVAC case and block recirculated cabin air, and the ram air throttling door open;

FIG. 2C illustrates the ram air throttling assembly of FIG. 2A in a fresh air mode with the mode door positioned to direct fresh ram air to the HVAC case and block recirculated cabin air, and the ram air throttling door in an intermediate (partially open) position for throttling flow of ram air into the assembly;

FIG. 3A illustrates an additional ram air throttling assembly in accordance with the present disclosure, the assembly configured in a fresh air mode with the ram air throttling door open and mode doors positioned to block recirculated cabin air from flowing to the HVAC case;

FIG. 3B illustrates the ram air throttling assembly of FIG. 3A configured in a recirculation mode with the ram air throttling door closed and the mode doors positioned to direct recirculated cabin air to the HVAC case.

FIG. 3C illustrates the ram air throttling assembly of FIG. 3A configured in a fresh air mode with the ram air throttling door partially open and the mode doors positioned to block recirculated cabin air from flowing to the HVAC case; and

FIG. 3D illustrates the ram air throttling assembly of FIG. 3A configured in an air-mix mode with the ram air throttling door partially open, a first mode door positioned to direct recirculated cabin air to the HVAC case, and a second mode door positioned to block recirculated cabin air from flowing to the HVAC case.

Corresponding reference numerals indicate corresponding parts throughout the several views of the drawings.

### DETAILED DESCRIPTION

Example embodiments will now be described more fully with reference to the accompanying drawings.

Vehicles typically include a heating, ventilation, and air conditioning (HVAC) system behind an instrument panel. The HVAC system includes an HVAC case with an evaporator and a heater. Connected to the HVAC case is a blower case including a blower, which blows air through the HVAC case to the passenger cabin. The air blown by the blower recirculates air from the passenger cabin, and/or fresh ram air from outside of the vehicle. The ram air is throttled to control the intensity at which the ram air enters the HVAC system.

Space behind and below the instrument panel is limited, and the HVAC system is subject to size constraints. Such size constraints are present on electric vehicles (EVs), internal combustion engine vehicles, and hybrid vehicles. It is thus desirable to provide the HVAC system with as small a footprint as possible.

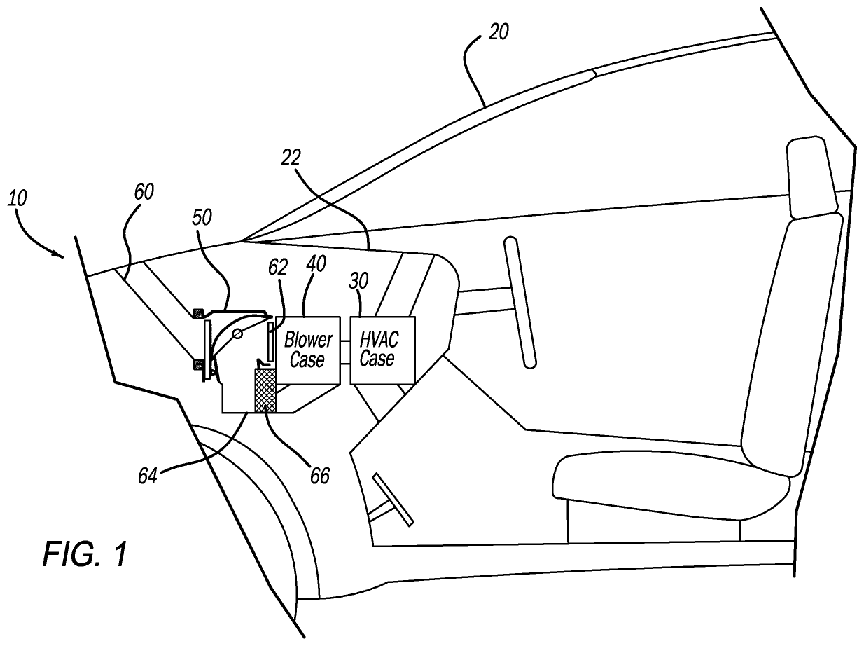

FIG. 1 illustrates an exemplary vehicle heating, ventilation, and air conditioning (HVAC) system 10 in accordance with the present disclosure. The HVAC system 10 is shown installed in an exemplary vehicle 20. The vehicle 20 may be any suitable vehicle powered in any suitable manner, such as a fully electric vehicle (EV), an internal combustion engine (ICE) vehicle, or a hybrid vehicle.

The vehicle HVAC system 10 is installed behind and below an instrument panel 22 of the vehicle 20. The HVAC system 10 generally includes an HVAC case 30, a blower case 40, and a ram air throttling assembly 50. The blower case 40 includes a blower configured to blow airflow through the HVAC case 30. The HVAC case 30 is configured to heat and cool airflow in any suitable manner. For example, the HVAC case 30 may include an evaporator to cool the airflow and a heater to heat the airflow. The heater may be a heater core or any other suitable heater. The ram air throttling assembly 50 is configured to selectively direct at least one of recirculated cabin air and/or fresh ram air to the blower case 40.

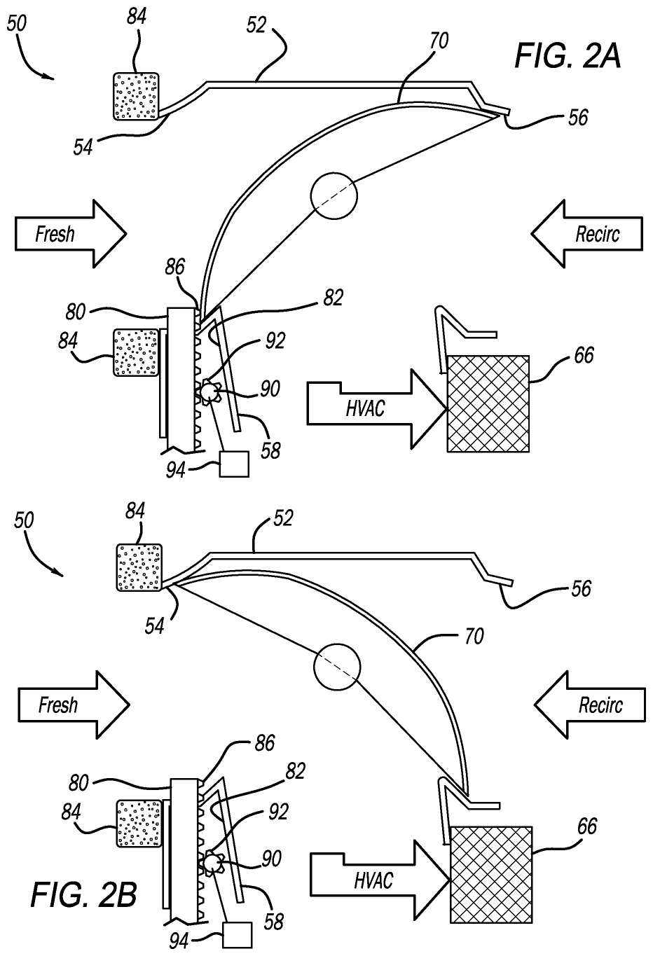

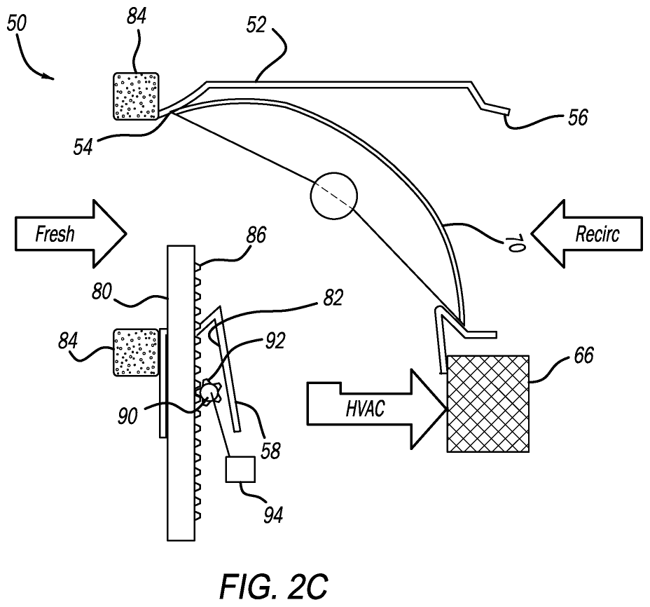

With continued reference to FIG. 1 and additional reference to FIGS. 2A and 2B, the ram air throttling assembly 50 will now be described in greater detail. The ram air throttling assembly 50 includes a housing 52. The housing 52 defines a ram air inlet 54, a recirculation air inlet 56, and an outlet 58. The ram air inlet 54 and the recirculation air inlet 56 are aligned and face each other in the example of FIGS. 2A and 2B, and the outlet 58 is between the ram air inlet 54 and the recirculation air inlet 56. The ram air inlet 54 receives ram air from a ram air channel 60 (FIG. 1), which has an opening at an exterior of the vehicle 20. Outside ram air flows through the ram air channel 60 into the housing 52 through the ram air inlet 54. The recirculation air inlet 56 receives recirculated cabin air from a recirculation air channel 62 (FIG. 1), which extends from the passenger cabin to the recirculation air inlet 56. The outlet 58 is connected to an HVAC channel 64 (FIG. 1), which directs airflow from the housing 52 through an air filter 66 and to the blower case 40. The blower case 40 blows the air through the HVAC case 30, which heats or cools the air. From the HVAC case 30, the heated and/or cooled air flows to the passenger cabin.

The ram air throttling assembly 50 further includes a mode door 70 and a ram air throttling door 80. The mode door 70 is also referred to herein as a first door, and the ram air throttling door 80 is also referred to as a second door. The mode door 70 is movable to direct airflow from one or both of the recirculation air inlet 56 and the ram air inlet 54 to the outlet 58. The mode door 70 may be any suitable airflow control door. In the example illustrated, the mode door 70 is a barrel door configured to rotate about an axis between the ram air inlet 54 and the recirculation air inlet 56. The mode door 70 may be rotated by any suitable servo, or in any other suitable manner.

FIG. 2A illustrates the mode door 70 is a recirculation mode. In the recirculation mode, the mode door 70 is positioned to allow recirculated cabin air to enter the ram air throttling assembly 50 through the recirculation air inlet 56, and positioned to block fresh ram air from entering through the ram air inlet 54. The ram air throttling door 80 may be open as illustrated, or at any other suitable position. FIG. 2B illustrates the mode door 70 in a fresh air mode. In the fresh air mode, the mode door 70 is positioned to allow fresh ram air to enter the housing 52 through the ram air inlet 54, and positioned to block recirculated cabin air from entering through the recirculation air inlet 56. The mode door 70 may also be moved to an intermediate air mix position at which the mode door 70 allows air to flow into the housing 52 from both the ram air inlet 54 and the recirculation air inlet 56.

The ram air throttling door 80 is slidably movable to throttle ram air into the housing 52 through the ram air inlet 54. The ram air throttling door 80 is seated within a pocket 82 defined by the housing 52, and is movable into and out of the pocket 82. In the example illustrated, the ram air throttling door 80 is generally configured as a plate. In a closed position, the ram air throttling door 80 fully extends out of the pocket 82 to close the ram air inlet 54. The housing 52 includes seals 84, which the ram air throttling door 80 is adjacent to when in the fully extended, closed position to seal the ram air inlet 54 closed. The seals 84 may be made of any suitable material, such as a suitable polymeric material.

The ram air throttling door 80 can be moved in any suitable manner. For example, the door 80 may include door teeth 86. Adjacent to the ram air throttling door 80 is a gear 90 with gear teeth 92. The gear teeth 92 mesh with the door teeth 86. Thus, rotation of the gear 90 slides the ram air door into and out of the pocket 82 in a direction generally perpendicular to ram airflow through the ram air inlet 54. The gear 90 may be rotated in any suitable manner, such as by any suitable servo motor 94. The ram air throttling door 80 is movable to a closed position in which the door 80 prevents ram air from entering the housing 52 through the ram air inlet 54, a fully open position (FIGS. 2A and 2B) in which the door 80 does not restrict ram air from entering the housing 52, and any suitable intermediate position (as illustrated in FIG. 2C, for example) between the fully open and closed positions in which the door 80 partially obstructs ram airflow to throttle ram airflow into the housing 52. In the recirculation mode of FIG. 2A, the ram air throttling door 80 may be in the fully open position as illustrated, or at any other suitable position. With respect to the fresh air mode, the ram air throttling door 80 may be fully open as illustrated in FIG. 2B, or at any suitable intermediate, partially open position as illustrated in FIG. 2C. The ram air throttling door 70 may also be partially open when the mode door 70 is in the air mix position in which airflow is allowed into the housing 52 through both the ram air inlet 54 and the recirculation air inlet 56.

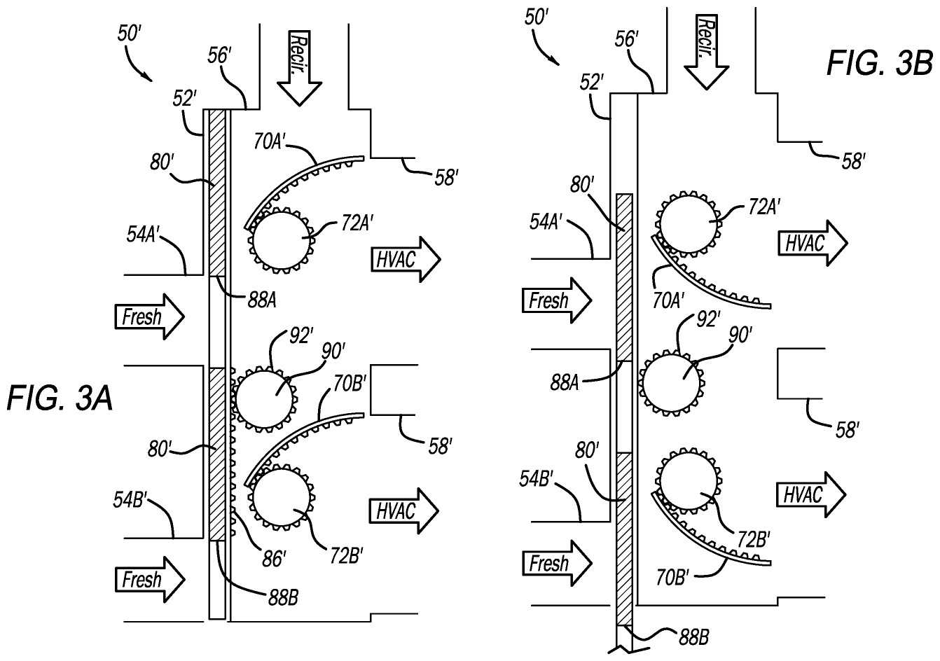

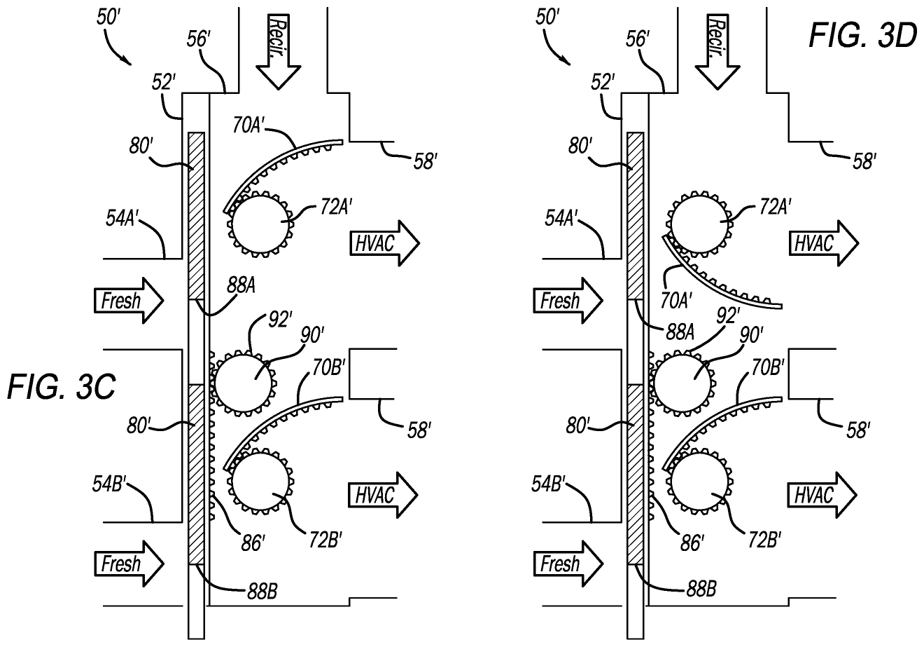

FIGS. 3A, 3B, 3C, and 3D illustrate another ram air throttling assembly 50′ in accordance with the present disclosure. The assembly 50′ is similar to the assembly 50, and thus similar features are designated in the drawings with the same reference numbers along with the prime (′) symbol. The description of the assembly 50 generally applies to the assembly 50′ except for the differences described below.

The assembly 50′ includes two or more vertically aligned ram air inlets. In the example of FIGS. 3A and 3B, the assembly includes a first ram air inlet 54A′ and a second ram air inlet 54B′. Outlets 58′ to the blower case 40 are opposite to the first and second ram air inlets 54A′ and 54B′. The recirculation air inlet 56′ is generally between the outlets 58′ and both the first and second ram air inlets 54A′ and 54B′. The housing 52′ has a width that is generally less than a width of the housing 52, and the housing 52′ has a vertical height that is generally greater than a vertical height of the housing 52. The dimensions and orientation of the housing 52′, and the presence of the two ram air inlets 54A′ and 54B′, make the assembly 50′ better suited than the assembly 50 for particular applications.

The ram air throttling door 80′ is slidably movable to simultaneously open and close the first and second ram air inlets 54A′ and 54B′. The ram air throttling door 80′ defines two openings 88A and 88B, which align with the ram air inlets 54A′ and 54B′ respectively when the ram air throttling door 80′ is in the open position of FIG. 3A. The two openings 88A, 88B of the ram air throttling door 80′ are not aligned with the ram air inlets 54A′ and 54B′ when the ram air throttling door 80′ is in the closed position of FIG. 3B. Rotation of the shaft 90′ slidably moves the ram air throttling door 80′ from the open position (FIG. 3A) to the closed position (FIG. 3B) as a result of cooperation between the shaft teeth 92′ and the door teeth 86′. The ram air throttling door 80′ may also be moved to a partially open position in which the ram air throttling door 80′ only partially obstructs the ram air inlets 54A′ and 54B′, as illustrated in FIGS. 3C and 3D.

The ram air throttling assembly 50′ includes a first mode door 70A′ and a second mode door 70B′. A first gear 72A′ includes teeth that mesh with teeth of the first mode door 70A′, and a second gear 72B′ includes teeth that mesh with teeth of the second mode door 70B′. The first gear 72A′ and the second gear 72B′ are rotatable in any suitable manner, such as with a servo. Rotation of the first gear 72A′ moves the first mode door 70A′ and rotation of the second gear 72B′ moves the second mode door 70B′.

In the configurations of FIG. 3A and FIG. 3C, the first and second mode doors 70A′, 70B′ are positioned to prevent recirculated cabin air from flowing to the blower case 40 and the HVAC case 30. In the configuration of FIG. 3B, the first and second mode doors 70A′, 70B′ are positioned to allow recirculated cabin air to flow to the blower case 40 and the HVAC case 30. The first and second mode doors 70A′, 70B′ may also be positioned in an intermediate air mix position whereby recirculated cabin air and fresh ram air is allowed to mix and flow out through the outlets 58′. With reference to FIG. 3D, the first mode door 70A′ may be positioned to allow recirculated cabin air to flow to the blower case 40 and the HVAC case 30, and the second mode door 70B′ may be positioned to prevent recirculated cabin air from flowing to the blower case 40 and the HVAC case 30.

The ram air throttling assemblies 50, 50′ advantageously take up a relatively small area under the instrument panel 22 due in part to the slidable ram air throttling doors 80, 80′. As a result, the passenger cabin area may be made larger and/or additional components may be accommodated behind the instrument panel 22. In general, the ram air throttling assemblies 50, 50′ free up valuable space behind the instrument panel 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle HVAC system including a ram air throttling assembly comprising:
a housing defining a ram air inlet, a recirculation air inlet, and an outlet;
a first door within the housing, the first door movable to direct airflow from at least one of the ram air inlet and the recirculation air inlet to the outlet; and
a second door slidably movable to throttle airflow into the housing through the ram air inlet.

2. The vehicle HVAC system of claim 1, wherein the first door is a barrel door.

3. The vehicle HVAC system of claim 1, wherein the outlet is in communication with a blower and an HVAC case of the vehicle HVAC system.

4. The vehicle HVAC system of claim 1, wherein the ram air inlet is opposite to the recirculation air inlet.

5. The vehicle HVAC system of claim 4, wherein the outlet is between the ram air inlet and the recirculation air inlet.

6. The vehicle HVAC system of claim 1, wherein the second door is slidably movable into and out of a pocket defined by the housing.

7. The vehicle HVAC system of claim 1, wherein the second door is slidably movable in a direction perpendicular to airflow through the ram air inlet.

8. The vehicle HVAC system of claim 1, wherein the second door includes a plate having door teeth meshed with gear teeth of a gear such that rotation of the gear slides the second door between an open position, a closed position, and an intermediate position between the open position and the closed position.

9. The vehicle HVAC system of claim 8, further comprising a motor configured to rotate the gear.

10. The vehicle HVAC system of claim 1, wherein:
the ram air inlet is a first ram air inlet;
the housing further defines a second ram air inlet; and
the second door is slidably movable to throttle airflow into the housing through both the first ram air inlet and the second ram air inlet.

11. The vehicle HVAC system of claim 10, wherein the first ram air inlet is vertically aligned with the second ram air inlet.

12. The vehicle HVAC system of claim 10, wherein the housing includes two of the first doors each adjacent to a different one of the first ram air inlet and the second ram air inlet.

13. A vehicle HVAC system including a ram air throttling assembly comprising:
a housing defining a ram air inlet, a recirculation air inlet, and an outlet;
a first door within the housing, the first door movable to direct airflow from at least one of the ram air inlet and the recirculation air inlet to the outlet; and
a second door at the ram air inlet, the second door configured as a plate slidably movable into and out of a pocket defined by the housing in a direction perpendicular to airflow through the ram air inlet to throttle airflow into the housing through the ram air inlet.

14. The vehicle HVAC system of claim 13, wherein:
the second door includes door teeth meshed with gear teeth of a gear such that rotation of the gear slides the second door between an open position, a closed position, and an intermediate position between the open position and the closed position; and
the vehicle HVAC system further includes a motor configured to rotate the gear.

15. The vehicle HVAC system of claim 13, wherein the ram air inlet is opposite to the recirculation air inlet.

16. The vehicle HVAC system of claim 13, wherein:
the ram air inlet is a first ram air inlet;
the housing further defines a second ram air inlet vertically aligned with the first ram air inlet; and
the second door is slidably movable to throttle airflow into the housing through both the first ram air inlet and the second ram air inlet.

17. A vehicle HVAC system comprising:
an HVAC case including an evaporator and a heater;
a blower connected to the HVAC case and configured to blow air through the HVAC case; and
a ram air throttling assembly connected to the blower, the ram air throttling assembly including:
a housing defining a ram air inlet, a recirculation air inlet, and an outlet;
a first door within the housing, the first door movable to direct airflow from at least one of the ram air inlet and the recirculation air inlet to the outlet; and
a second door slidably movable to throttle airflow into the housing through the ram air inlet.

18. The vehicle HVAC system of claim 17, wherein:
the second door includes door teeth meshed with gear teeth of a gear such that rotation of the gear slides the second door between an open position, a closed position, and an intermediate position between the open position and the closed position; and
the vehicle HVAC system further includes a motor configured to rotate the gear.

19. The vehicle HVAC system of claim 17, wherein the ram air inlet is opposite to the recirculation air inlet.

20. The vehicle HVAC system of claim 17, wherein:
the ram air inlet is a first ram air inlet;
the housing further defines a second ram air inlet vertically aligned with the first ram air inlet; and
the second door is slidably movable to throttle airflow into the housing through both the first ram air inlet and the second ram air inlet.
